(19) United States
(12) Patent Application Publication
(10) Pub. No.: US 2007/0214804 A1
(43) Pub. Date: Sep. 20, 2007

(54) Onboard Regasification of LNG

(76) Inventors: Robert John Hannan, Perth (AU); Solomon Aladja Faka, Woodland Hills, CA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/559,136

(22) Filed: Nov. 13, 2006

Related U.S. Application Data
(60) Provisional application No. 60/782,282, filed on Mar. 15, 2006.

(51) Int. Cl. F17C 9/02

(52) U.S. Cl. 62/50.2

(57) ABSTRACT

A method is provided for offshore regasification of liquid natural gas (LNG) for delivery onshore as a gas. The method includes offloading LNG from a first LNG Carrier to a second LNG Carrier at an offloading location, the second LNG Carrier including an onboard regasification facility, transferring the second LNG Carrier from the offloading location to a mooring location closer to shore, regasifying the LNG onboard the second LNG Carrier to form natural gas, and transferring the regasified natural gas to an onshore gas distribution facility for delivery to an end user.

### CROSS-REFERENCE TO RELATED APPLICATION

This application claims priority from U.S. Provisional Patent Application Ser. No. 60/782,282, entitled “Onboard Regasification of LNG” and filed Mar. 15, 2006. The disclosure of the above-identified patent application is incorporated herein by reference in its entirety.

### FIELD OF THE INVENTION

The present invention relates to a method and apparatus for onboard regasification of liquefied natural gas (“LNG”).

### BACKGROUND TO THE INVENTION

Natural gas (“NG”) is routinely transported from one location to another location in its liquid state as “Liquefied Natural Gas (“LNG”). Liquefaction of the natural gas makes it more economical to transport as LNG occupies only about 1/600^{th} of the volume that the same amount of natural gas does in its gaseous state. LNG is typically stored in cryogenic containers either at or slightly above atmospheric pressure. LNG is normally regasified before distribution to end users through a pipeline or other distribution network at a temperature and pressure that meets the delivery requirements of the end users. Regasification of the LNG is most commonly achieved by raising the temperature of the LNG above the LNG boiling point for a given pressure.

Transportation of LNG from one location to another is most commonly achieved using ocean-going vessels with cryogenic storage capability referred to as “LNG Carriers”. It is common for an LNG Carrier to berth at a pier or jetty and offload the LNG as a liquid to an onshore storage and regasification facility. The regasification facility typically comprises a plurality of heat exchangers or vaporisers, pumps and compressors. Such onshore storage and regasification facilities are typically large and the costs associated with building and operating such facilities are significant.

Recently, public concern over safety of onshore regasification facilities has led to the building of offshore regasification terminals which are removed from populated areas and onshore activities. Various offshore terminals with different configurations and combinations have been proposed. In one example, regasification takes place onboard an LNG Carrier which has been modified so that the regasification facility travels with the LNG Carrier. The LNG Carrier is loaded with LNG at one location and then travels across the ocean to another location where it is moored offshore. The LNG onboard the LNG Carrier is regasified and delivered to shore through a subsea pipeline connected by risers to the mooring buoy.

In another example, an offshore regasification terminal is used which includes a barge fitted with cryogenic storage tanks. The barge is permanently moored to and able to weathervane around a mooring buoy. The barge is typically longer than an LNG Carrier to assist in side-by-side berthing of the LNG Carrier alongside the barge so that the LNG can be offloaded from the LNG Carrier into the storage tanks onboard the permanently moored barge. The barge includes at least one regasification unit which is typically built on top of the storage tanks. Regasified natural gas flows from the barge to shore through a sub-sea pipeline which is connected to the barge through a marine riser connected to the mooring buoy.

Various mediums and various types of vaporisers have been used to regasify LNG. For example, U.S. Pat. No. 6,089,022 describes a method to regasify LNG onboard an LNG tanker before transferring the re-vaporized natural gas to an onshore facility. The pressure of the LNG is boosted substantially while the LNG is in its liquid phase and before it is flowed through a vaporizer positioned aboard the vessel. Seawater is taken from the body of water surrounding the vessel and is flowed through the vaporizer to heat and vaporize the LNG to natural gas before the natural gas is off-loaded to onshore facilities. The use of seawater is problematic and expensive due its highly corrosive nature. The main concerns however are the presence of organisms in the seawater which may well be killed and the environmental impact of cooled seawater returned to the marine environment.

U.S. Pat. No. 4,170,115 describes an apparatus for vaporizing liquefied natural gas using estuarine water. The apparatus comprises a series of heat exchangers of the indirect heating, intermediate fluid type. The LNG is vaporised using a heating medium being a refrigerant vaporized using estuarine water as a heat source and having a temperature not higher than the freezing point of the estuarine water. A multi-tubular concurrent heat exchanger is used to bring the low-temperature vaporized natural gas from the heat exchanger into concurrent contact with estuarine water serving as a heat source to heat the vaporized natural gas. U.S. Pat. No. 4,224,802 describes a variation on this type of apparatus that also uses estuarine water in a multi-tubular heat exchanger.

U.S. Pat. No. 4,331,129 describes the utilization of solar energy for LNG vaporization. Solar energy is used to heat an intermediate fluid such as water. The heated water is then used to regasify the LNG. The water contains an anti-freeze additive so as to prevent freezing of the water during the vaporization process.

U.S. Pat. No. 4,399,660 describes an atmospheric vaporizer suitable for vaporizing cryogenic liquids on a continuous basis. The vaporiser employs heat absorbed from the ambient air and comprises at least three substantially vertical passes are piped together. Each pass includes a centre tube with a plurality of fins substantially equally spaced around the tube.

U.S. Pat. No. 5,251,452 also describes an ambient air vaporizer and heater for cryogenic liquids. This apparatus utilizes a plurality of vertically mounted and parallel connected heat exchange tubes. Each tube has a plurality of external fins and a plurality of internal peripheral passageways symmetrically arranged in fluid communication with a central opening. A solid bar extends within the central opening for a predetermined length of each tube to increase the rate of heat transfer between the cryogenic fluid in its vapor phase and the ambient air. The fluid is raised from its boiling point at the bottom of the tubes to a temperature at the top suitable for manufacturing and other operations.

U.S. Pat. No. 6,622,492 describes apparatus and process for vaporizing liquefied natural gas including the extraction of heat from ambient air to heat circulating water. The heat exchange process includes a heat exchanger for the vaporization of liquefied natural gas, a circulating water system, and a water tower extracting heat from the ambient air to heat the circulating water. To make the process work throughout the year the process may be supplemented by a submerged fired heater connected to the water tower basin.

U.S. Pat. No. 6,644,041 describes a process for vaporizing liquefied natural gas including passing water into a water tower so as to elevate a temperature of the water, pumping the elevated temperature water through a first heat exchanger, passing a circulating fluid through the first heat exchanger so as to transfer heat from the elevated temperature water into the circulating fluid, passing the liquefied natural gas into a second heat exchanger, pumping the heated circulating fluid from the first heat exchanger into the second heat exchanger so as to transfer heat from the circulating fluid to the liquefied natural gas, and discharging vaporized natural gas from the second heat exchanger.

U.S. Pat. No. 5,819,542 describes a heat exchange device having a first heat exchanger for evaporation of LNG and a second heat exchanger for superheating of gaseous natural gas. The heat exchangers are arranged for heating these fluids by means of a heating medium and having an outlet which is connected to a mixing device for mixing the heated fluids with the corresponding unheated fluids. The heat exchangers comprise a common housing in which they are provided with separate passages for the fluids. The mixing device constitutes a unit together with the housing and has a single mixing chamber with one single fluid outlet. In separate passages, there are provided valves for the supply of LNG in the housing and in the mixing chamber.

Despite the progress achieved through the piror art, there remains a need to explore other methods for offshore regasification of LNG.

All of the patents cited in this specification, are herein incorporated by reference. It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### SUMMARY OF THE INVENTION

According to one aspect of the present invention, there is provided a method for offshore regasification of liquid natural gas (LNG) for delivery onshore as a gas, the method comprising:
offloading LNG from a first LNG Carrier to a second LNG Carrier at an offloading location, the second LNG Carrier including an onboard regasification facility; transferring the second LNG Carrier from the offloading location to a mooring location closer to shore;
regasifying the LNG onboard the second LNG Carrier to form natural gas; and,
transferring the regasified natural gas to an onshore gas distribution facility for delivery to an end user.

Preferably the LNG is offloaded from the first LNG Carrier to the second LNG Carrier using side-by-side loading on one side of the second LNG Carrier. In one embodiment, the first and second LNG Carriers are underway and traveling side-by-side when LNG is offloaded from the first LNG Carrier to the second LNG Carrier. Alternatively, the first and second LNG Carriers are drifting side-by-side when LNG is offloaded from the first LNG Carrier to the second LNG Carrier. To protect the first and second LNG Carriers during offloading, the second LNG Carrier may be provided with fendering equipment or mooring facilities to allow side-to-side offloading with the first LNG Carrier. In addition, one or both LNG Carriers can be configured to facilitate tandem offloading from the first LNG Carrier to the second LNG Carrier.

Preferably the second LNG Carrier is provided with one or more storage tanks that are hydrostatically stable when partially filled with LNG. In one embodiment, the LNG is stored in the hull of the second LNG Carrier in slosh tolerant tanks and the second LNG Carrier has an associated supporting hull structure.

In one embodiment, the second LNG Carrier has reduced engine capacity compared with the engine capacity of the first LNG Carrier due to their different duties. To allow the second LNG Carrier to move under its own power, the second LNG Carrier has a propulsion system 80. The propulsion system 80 may comprise dual fuel gas turbines, dual fuel diesel, or duel fuel diesel-electric systems. Advantageously, the power requirement for the propulsion system 80 of the second LNG Carrier may be shared with the power requirement of the regasification facility 30 onboard the second LNG Carrier 14.

To provide the second LNG Carrier with mooring and positioning capability, the propulsion system of the second LNG Carrier may comprise twin screw, fixed pitch propellers 63 with transverse thrusters 64 located both forward and aft.

In a preferred embodiment, the mooring location includes a mooring buoy removably disconnectable to the second LNG Carrier for mooring the second LNG Carrier at the mooring location, the mooring buoy being locatable within a recess disposed within the hull and towards the bow of the second LNG Carrier. Preferably the mooring buoy is a submersible turret mooring buoy which can be lowered to the sea floor when not in use to protect the buoy from damage. In one embodiment, the natural gas is transferred to shore through the mooring buoy. Preferably, the natural gas is transferred from the second LNG Carrier through a subsea pipeline to an on-shore tie-in point via a beach crossing.

In one embodiment, the LNG is regasified using ambient air as a source of heat. The LNG may equally be regasified through heat exchange with an intermediate fluid with the intermediate fluid being heated using ambient air as a source of heat. Advantageously, heat exchange between the ambient air and the LNG or intermediate fluid may be encouraged through use of forced draft fans.

To meet delivery requirements, the method may further comprise the step of flowing regasified natural gas into a second heat exchanger in which the regasified natural gas is heated and is transferred to shore as superheated vapor. The regasified natural gas may be heated in the second heat exchanger using waste heat recovery from the second LNG Carrier. The LNG may be regasified in a closed loop heat exchanger or a finned tube heat exchanger.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a schematic plan view of a first embodiment of the method of onboard regasification of the present invention illustrating the first and second LNG Carrier positioned at an offloading location during offloading of the LNG from the first LNG Carrier to the second LNG Carrier fitted with an onboard regasification facility;

FIG. 2 is a schematic side view of the embodiment of FIG. 1 illustrating the second LNG Carrier moored at a turret mooring buoy as the LNG is regasified onboard the second LNG Carrier and transferred through a marine riser and associated sub-sea pipeline to shore; and,

FIG. 3 illustrates one possible flow diagram for the regasification facility onboard the second LNG Carrier.

### DETAILED DESCRIPTION OF PREFERRED EMBODIMENTS

Particular embodiments of the method for offshore regasification of LNG for delivery onshore as a gas of the present invention are now described. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs.

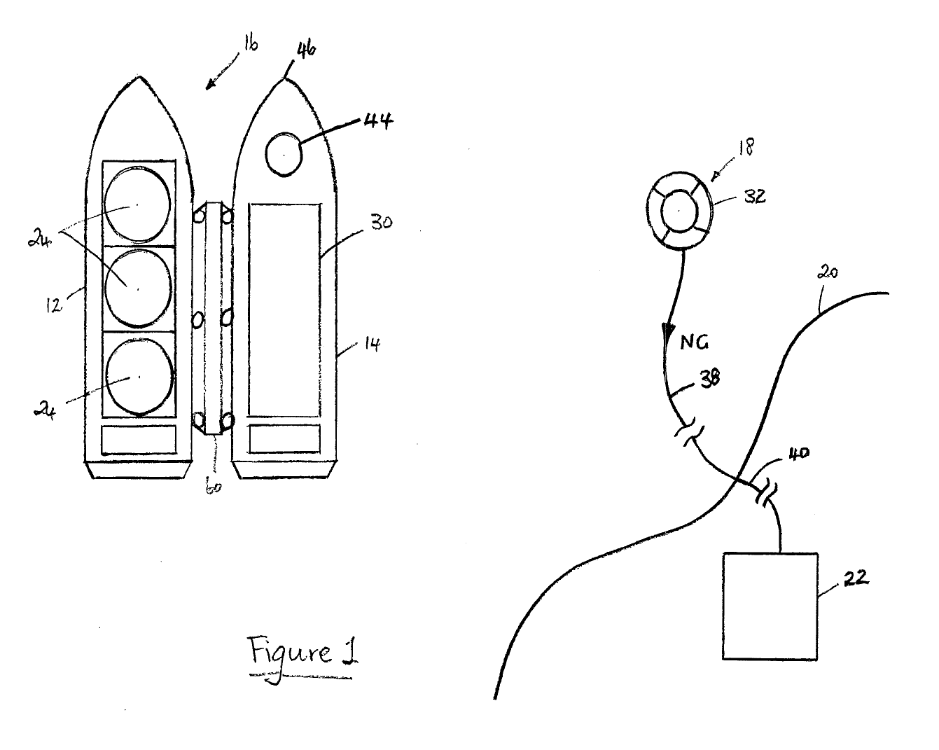

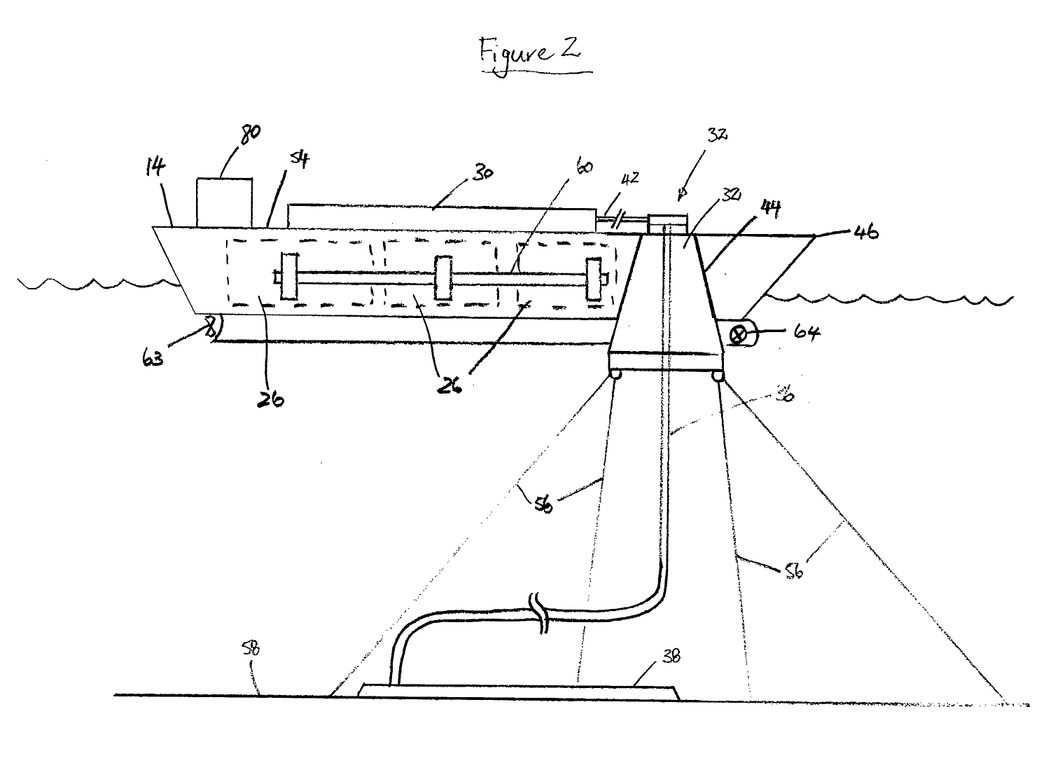

A first embodiment is now described with reference to FIGS. 1 and 2. In this embodiment, a first LNG Carrier 12 is loaded with LNG at an export terminal located adjacent to an onshore liquefaction facility or associated natural gas wells or pipelines. The loaded first LNG Carrier 12 then travels from the export terminal to an import terminal which may be located in a different country to the export terminal. Upon arrival at the import terminal, a second LNG Carrier 14 provided with an onboard regasification facility 30 is dispatched to dock with the first LNG Carrier 12 at an offloading location (generally designated by the reference numeral 16). The offloading location 16 can be any location where the first and second LNG Carriers 12 and 14 respectively, can be moored together to facilitate offloading of the LNG from the first LNG Carrier 12 to the second LNG Carrier 14. LNG is offloaded from the first LNG Carrier 12 to the second LNG Carrier 14 at the offloading location 16. The second LNG Carrier 14 is then transferred from the offloading location 16 to a mooring location 18 closer to the shore 20. LNG stored onboard the second LNG Carrier 14 is regasified onboard the second LNG Carrier 14 to form natural gas (NG) which is then transferred to an onshore gas distribution facility 22. After the LNG is offloaded from the first LNG Carrier 12 to the second LNG Carrier 14, the first LNG Carrier 12 can sail away back to export terminal or another location for reloading.

LNG is stored aboard the first LNG Carriers 12 in cryogenic storage tanks 24. Examples of suitable storage systems include the cryogenic storage systems described in U.S. Pat. No. 6,378,722; U.S. Pat. No. 6,263,818; U.S. Pat. No. 5,727,492; U.S. Pat. No. 5,529,239; or U.S. Pat. No. 5,099,779, the contents of which are incorporated herein by reference.

The second LNG Carrier 14 is provided with storage tanks 26 and a supporting hull structure capable of withstanding the loads imposed from intermediate filling levels while the vessel is subject to harsh, multi-directional environmental conditions. When the second LNG Carrier 14 moors alongside first LNG Carrier 12, LNG from the storage tanks 24 aboard the first LNG Carrier 12 is offloaded into the storage tanks 26 of the second LNG Carrier 14. In a preferred embodiment, the storage tanks 26 onboard the second LNG Carrier 14 are robust to sloshing of the LNG when the storage tanks 26 are partly filled or when the second LNG Carrier 14 is riding out a storm while positioned at the mooring location 18 whilst transferring natural gas to the onshore distribution facility 22. To reduce the effects of sloshing, the storage tanks 26 can be provided with a plurality of internal baffles and/or reinforced membranes, provided that the storage tanks are hydrostatically stable when partially filled with LNG. The storage tanks can also be provided with SPB type B membrane tanks to reduce the effect of sloshing. Self supporting spherical cryogenic storage tanks, for example the Moss type, are not considered to be suitable for the storage tanks 26 of the second LNG Carrier 14 as they reduce the deck area available to position the regasification facility on the deck of the second LNG Carrier 14. Offloading of LNG from the first LNG Carrier 12 to the second LNG Carrier 14 can be achieved using any of the offloading methods well established in the industry. For example, U.S. Pat. No. 6,637,479 describes a system for offshore transfer of liquefied natural gas between two vessels. The system comprises a coupling head mounted at one end of a flexible pipe means and arranged for attachment on a platform at one end of one vessel when it is not in use, and a connection unit mounted at one end of the other vessel and comprising a pull-in funnel shaped for guided pull-in of the coupling head to a locking position in which the pipe means can be connected to transfer pipes on the other vessel via a valve means arranged in the coupling head. The coupling head is provided with a guide means and is connected to at least one pull-in wire for guided pull-in of the coupling head into the connection unit by a winch means on the other vessel.

In one embodiment of the present invention, offloading or “lightering” occurs whilst the first and second LNG Carriers 12 and 14 respectively are moored together and are travelling side by side, either underway or drifting. A key advantage of lightering is that it removes the differential movement that otherwise occurs when two vessels are moored side-by-side at sea. When lightering is used, it is advantageous for the storage tanks 24 on the first LNG Carrier 12 to also be robust to sloshing to better withstand the forces generated as the level of LNG in the first LNG Carrier 12 is reduced during offloading.

The second LNG Carrier 14 is provided with fendering equipment 60 as well as optional mooring facilities to facilitate side-to-side offloading with the first LNG Carrier 12. The fendering equipment protects the first and second Carriers from damage during side-by-side loading and is of a similar type to that provided at a berth at a conventional import terminal, the difference being that the fendering equipment 60 is disposed on one side of the second LNG Carrier 12. Ballasting devices (not shown) can be used to ensure that the freeboard of the second LNG Carrier 14 is maintained substantially the same as that of the LNG carrier during offloading operations if desired.

The holding capacity of the storage tanks 26 onboard the second LNG Carrier 14 may be the same or similar to the holding capacity of the storage tanks 24 aboard the first LNG Carrier 12, so that the entire payload of LNG onboard the first LNG Carrier 12 can be transferred to the second LNG Carrier 14. It is equally possible for the holding capacity of the storage tanks 26 onboard the second LNG Carrier 14 to be less than the holding capacity of the storage tanks 24 aboard the first LNG Carrier 12. In this scenario, the first LNG Carrier 12 may need to offload its payload to more than one second LNG Carrier 14 before returning to export terminal for reloading or remain at the offshore offloading location 16 until the second LNG Carrier 14 returns for a second load.

The method of the present invention provides significant cycle time advantages over prior art methods of onboard regasification which rely on regasification facilities being provided on the LNG Carrier that delivers the LNG from the export terminal to the import terminal. Such modified prior art LNG Carriers are obliged to remain at the delivery location until the cargo of LNG has been regasified which results in significant delays in returning to its export terminal for reloading. Moreover, the time spent at the delivery location can be dependent on the rate of consumption of the gas. This problem is overcome using the methods of the present invention.

When offloading of the LNG from the first LNG Carrier 12 to the second LNG Carrier 14 is completed, the second LNG Carrier 14 travels under its own power from the offloading location 16 to a mooring location (generally designated by the reference numeral 18) that is closer to the shore 20 than the offloading location 16. The second LNG Carrier 14 can be a modified ocean-going LNG Carrier or a custom built vessel. In one embodiment of the present invention, the second LNG Carrier 14 is not required to perform ocean-going duty but is only required to sail under its own power from the offshore offloading location to the mooring location in normal operation. Thus the main propulsion system of the second LNG Carrier 14 has a modified and reduced duty compared with the main propulsion system of the ocean-going first LNG Carrier 12.

It is to be understood that the second LNG Carrier 14 can be fitted with a power system that enables it to travel under its own power between an import terminal and an outport terminal if required. However, to be economic, the first LNG Carrier 12 should travel the larger part of the distance between the export terminal and the import terminal, leaving the second LNG Carrier 14 to travel as short a distance as possible between the offloading location 16 and the mooring location 18.

Conventional ocean-going LNG Carriers rely on steam propulsion plants for power. Steam is used primarily due to the ease of burning the boil-off gas from the LNG storage tanks on the LNG Carrier. A number of patents have been granted in relation to power plants and turbine systems for an LNG Carrier including U.S. Pat. No. 6,609,360; U.S. Pat. No. 6,598,401; U.S. Pat. No. 6,581,368; U.S. Pat. No. 6,374,591; U.S. Pat. No. 6,367,258; U.S. Pat. No. 5,457,951; U.S. Pat. No. 4,995,234; and US Patent Application Number 20050061002, all of which are incorporated herein by reference.

Because of the different, and in some cases, reduced duty of the second LNG Carrier 14 compared with the first LNG Carrier, the main boilers on the second LNG Carrier 14 can be converted into gas-burning units to provide power for propulsion of the second LNG Carrier 14. In one embodiment of the present invention, the second LNG Carrier 14 is provided with a series of dual fuelled engines, for example a combination of gas and diesel engines which are more efficient than turbines and do not require the specialised maintenance crew that would otherwise be required for steam turbines. In another embodiment, dual fuelled diesel engines are direct coupled to generators and electrical power so generated is directed to electric motors to drive the propeller shafts as well as to any electrically powered LNG pumps, fans or other equipment associated with the onboard regasification facility 30. Electricity is also used for the hotel load associated with an accommodation unit onboard the second LNG Carrier 14. Use of dual fuelled engines enables the power to be directed to propulsion when the second LNG Carrier 14 is under way and to regasification when the second LNG Carrier 14 is positioned at the mooring location 18. It also simplifies the powering of manoeuvring devices such as bow thrusters 64 to facilitate mooring. The above described power sharing enables an overall reduction in installed power and all power generation by the most efficient engines available.

With reference to the embodiment illustrated in FIG. 2, the natural gas that is produced in the regasification facility 30 provided onboard the second LNG Carrier 14 is transferred via the gas delivery line 42 to the turret mooring buoy 32. When the second LNG Carrier 14 connects to the mooring buoy 32 it becomes moored at the mooring location 18. A flexible marine riser 36 (best seen in FIG. 2) is used to transfer natural gas from the regasification facility 30 to the onshore gas distribution facility 22. The marine riser 36 is fluidly connected at its upper end to the turret mooring buoy 32 and is fluidly connected at its lower end to a sub-sea pipeline 38 that travels across a beach crossing 40 to the onshore gas distribution facility 22.

A key advantage of the use of a second LNG Carrier 14 over a permanently moored offshore storage structure is that the second LNG Carrier 14 can disconnect from the mooring location 18 and travel under its own power offshore to avoid extreme weather conditions or threat of terrorism or to transit to a dockyard or transit to another LNG import or export terminal. Similarly, if demand for gas no longer exists at a particular location, the second LNG Carrier 14 may need to sail under its own power to another location where demand is higher. In this event, the second LNG Carrier 14 may do so without LNG stored onboard during this journey or with a reduced load.

With reference to the embodiment illustrated in FIG. 2, the second LNG Carrier 14 is designed or retrofitted to include a recess or “moonpool” 44 to facilitate docking of the second LNG Carrier 14 with an internal turret mooring buoy 32. This is done in a manner that permits the second LNG Carrier 14 to weathervane around the turret mooring buoy 32. To facilitate weathervaning, the moonpool 44 is positioned towards the bow 46 of the second LNG Carrier 14. An example of a suitable type of turret mooring systems is described in U.S. Pat. No. 6,688,114, the contents of which are incorporated herein by reference. Where prevailing weather is highly directional, spread mooring can be used as an alternative. Such locations are not common.

The mooring buoy 32 is moored by anchor lines 56 to the seabed 58. The mooring buoy 32 is provided with one or more marine risers 36 which serve as conduits for the delivery of regasified natural gas through the mooring buoy 32 to the sub sea pipeline 38. Fluid connections are made between the inlet of the marine risers 36 and a gas delivery line 42 from the regasification facility 30 onboard the second LNG Carrier 14. A rigid arm connection over the bow 46 of the second LNG Carrier to a riser turret mooring could equally be used, but is not preferred. To allow the second LNG Carrier 14 to pick up the mooring buoy 32 without assistance, the second LNG Carrier 14 is highly manoeuvrable. In one embodiment, the second LNG Carrier 14 is provided with directionally controlled propellers which are capable of 360 degree rotation. The second LNG Carrier 14 has a propulsion system which comprises twin screw, fixed pitch propellers with transverse thrusters located both forward and aft that provide the second LNG Carrier with mooring and position capability. This high level of manoeuvrability comes in handy if the second LNG Carrier 14 transits to a dry dock (not shown).

Several companies have developed patented processes related to offloading LNG from carriers or related to suitable mooring systems. These companies include the following: Buoy Moorings Inc (U.S. Pat. No. 6,811,355, U.S. Pat. No. 6,692,192; U.S. Pat. No. 6,623,043; U.S. Pat. No. 6,623,043; U.S. Pat. No. 6,517,290); Bluewater Terminal Systems N.V. (U.S. Pat. No. 6,354,376; U.S. Pat. No. 6,244,920; U.S. Pat. No. 6,109,830; U.S. Pat. No. 5,944,840; U.S. Pat. No. 5,584,607); SOFEC, Inc (U.S. Pat. No. 5,292,271; U.S. Pat. No. 5,240,466; U.S. Pat. No. 5129848; U.S. Pat. No. 5,372,531; U.S. Pat. No. 5,356,321; U.S. Pat. No. 5,316,509; U.S. Pat. No. 5,306,186); and FMC Technologies (US patent application number 20040094082, 20040025772 and 20030226487). All of these patents are incorporated herein by reference.

With reference to FIG. 2, the regasification facility 30 is disposed on the deck 54 of the second LNG Carrier 14. A high pressure onboard piping system 28 is used to convey LNG from the storage tanks 26 to the regasification facility 30 via at least one cryogenic pump 70. Examples of suitable cryogenic pumps include a centrifugal pump, a positive-displacement pumps, a screw pump, a velocity-head pump, a rotary pump, a gear pump, a plunger pump, a piston pump, a vane pump, a radial-plunger pumps, a swash-plate pump, a smooth flow pump, a pulsating flow pump, or other pumps that meet the discharge head and flow rate requirements of the vaporizers. The capacity of the pump is selected based upon the type and quantity of vaporizers installed, the surface area and efficiency of the vaporizers and the degree of redundancy desired.

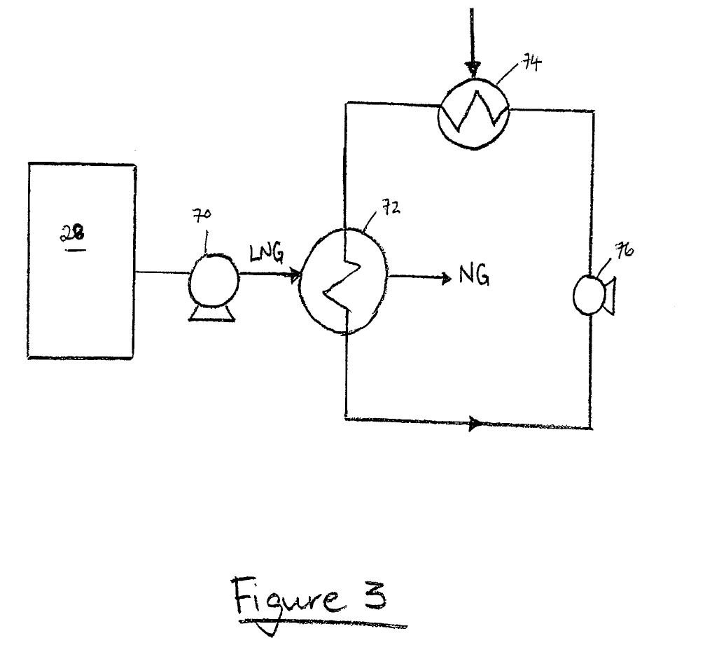

With reference to FIG. 3, the regasification facility 30 includes at least one vaporizer 72 for regasifying LNG to natural gas. LNG is regasified in the vaporiser 72 and exits the vaporiser 72 in the form of natural gas (NG). The heat necessary for onboard regasification can come from a number of possible sources. Vaporizers that use ambient air as the source of heat are preferred to reduce environmental impact and to keep emissions of nitrous oxide, sulphur dioxide, carbon dioxide and particulate matter to a minimum. To take advantage of the heating capacity of ambient air, the vaporiser 72 is preferably arranged on the deck 54 of the second LNG vessel. Ambient air may be used as the primary or only source of heat for regasification of the LNG or can be used in combination with a secondary source of heat.

The secondary source of heat can be used either for regasification of the LNG or to superheat the natural gas that has already been regasified. When ambient air is used as the primary source of heat for vaporisation, the secondary source of heat is used to reduce the effects of freezing up of the vaporisers. Suitable secondary sources of heat include waste heat recovery from the propulsion system, steam from a boiler or other source, a submerged combustion vaporizer, solar energy, electric water heaters using the excess electric generating capacity of the propulsion plant when the second LNG Carrier is moored, exhaust gas heat exchangers fitted to the combustion exhausts of the diesel engines and gas turbines, or natural gas fired hot water or thermal oil heaters. The secondary source can equally be generated by direct firing when additional heat is needed. The secondary source of heat may equally be used to heat an intermediate fluid that exchanges heat with the LNG or the natural gas. Suitable intermediate fluids are glycol, propane, salt water or fresh water or any other fluid with an acceptable heat capacity and boiling point that is commonly known to a person skilled in the art.

The vaporizer can be arranged such that ambient air exchanges heat directly with the LNG or the ambient air can be used to heat an intermediate fluid in a separate heat exchanger, with the heated intermediate fluid then being pumped to the vaporizer where it exchanges heat with the LNG being regasified. In the embodiment illustrated in FIG. 3, an intermediate fluid is circulated around a closed loop through the vaporizer 72 using a pump 76. Heat exchange between the intermediate fluid and the LNG results in regasification of the LNG to natural gas and significant cooling of the intermediate fluid. The intermediate fluid is reheated in a heat exchanger 74 using ambient air or another source of heat, for example any of the secondary sources of heat referred to above. This makes it easy to add heat into the intermediate fluid and so limit freezing of vaporizer 72.

The use of ambient air as a source of heat for onboard regasification has not previously been used or proposed. Existing onshore vaporizers are not necessarily suitable for onboard regasification duty. Modification is made to assure uniform distribution of LNG in the tubes, to remove condensation on the external surfaces of the vaporisers, to accommodate the differential thermal contraction between the LNG and the source of heat for regasification, to control fog that is generated around the vaporisers and to accommodate the added loads from shipboard accelerations. The materials used for the pumps, vaporizers and piping associated with the onboard regasification facility 30 should be selected to withstand the corrosive effects of seawater. A variety of materials that are suitable for use in marine environments are well known to persons skilled in the relevant art.

The vaporisers have to be capable of the structural loads associated with being disposed on the deck of an LNG Carrier that transits or is moored offshore. The fans for the forced system must be OK with the ship moving while vaporising during a storm. This means accelerations and possibly green water loads.

The size and surface area of the vaporizer 72 can vary widely, depending upon the volume and flow rate of LNG being regasified for delivery and the type of heat source being used. When ambient air is being used as a source of heat, the temperature of the ambient air can vary according to the seasons. To provide sufficient surface area for heat exchange, a plurality of vaporizers 72 can be arranged in a variety of configurations, for example in series or in banks. The type of vaporizer could equally be a shell and tube heat exchanger, a finned tube heat exchanger, a bent-tube fixed-tube-sheet exchanger, a spiral tube exchanger, a plate-type heat exchanger, an intermediate fluid vaporizer, a submerged combustion vaporizer or any other heat exchanger commonly known by those skilled in the art that meets the temperature, volumetric and heat absorption requirements for LNG to be regasified.

Now that several embodiments of the invention have been described in detail, it will be apparent to persons skilled in the relevant art that numerous variations and modifications can be made without departing from the basic inventive concepts. All such modifications and variations are considered to be within the scope of the present invention, the nature of which is to be determined from the foregoing description and the appended claims.

What is claimed:

1. A method for offshore regasification of liquid natural gas (LNG) for delivery onshore as a gas, the method comprising:
offloading LNG from a first LNG Carrier to a second LNG Carrier at an offloading location, the second LNG Carrier including an onboard regasification facility;
transferring the second LNG Carrier from the offloading location to a mooring location closer to shore;
regasifying the LNG onboard the second LNG Carrier to form natural gas; and,
transferring the regasified natural gas to an onshore gas distribution facility for delivery to an end user.

2. The method of claim 1, wherein the LNG is offloaded from the first LNG Carrier to the second LNG Carrier using side-by-side loading on one side of the second LNG Carrier.

3. The method of claim 2, wherein the first and second LNG Carriers are underway and traveling side-by-side when LNG is offloaded from the first LNG Carrier to the second LNG Carrier.

4. The method of claim 2, wherein the first and second LNG Carriers are drifting side-by-side when LNG is offloaded from the first LNG Carrier to the second LNG Carrier.

5. The method of claim 2, wherein the second LNG Carrier is provided with fendering equipment and mooring facilities to allow side-to-side offloading with the first LNG Carrier.

6. The method of claim 2, wherein the first and second LNG Carriers are traveling in tandem when LNG is offloaded from the first LNG Carrier to the second LNG Carrier by tandem offloading.

7. The method of claim 1, wherein the second LNG Carrier is provided with one or more storage tanks and the storage tanks are hydrostatically stable when partially filled with LNG.

8. The method of claim 1, wherein the LNG is stored in the hull of the second LNG Carrier in slosh tolerant tanks and the second LNG Carrier has an associated supporting hull structure.

9. The method of claim 1, wherein the second LNG Carrier has reduced engine capacity compared with the engine capacity of the first LNG Carrier.

10. The method of claim 1, wherein the second LNG Carrier has a propulsion system and the propulsion system comprises dual fuel gas turbines, dual fuel diesel, or duel fuel diesel-electric systems.

11. The method of claim 1, wherein the power requirement for the propulsion system of the second LNG Carrier is shared with the power requirement for regasification onboard the second LNG Carrier.

12. The method of claim 1, wherein the propulsion system comprises twin screw, fixed pitch propellers with transverse thrusters located both forward and aft that provide the second LNG Carrier with mooring and position capability.

13. The method of claim 1, wherein the mooring location includes a mooring buoy removably disconnectable to the second LNG Carrier for mooring the second LNG Carrier at the mooring location, the mooring buoy being locatable within a recess disposed within the hull and towards the bow of the second LNG Carrier.

14. The method of claim 13, wherein the mooring buoy is a submersible turret mooring buoy.

15. The method of claim 13, wherein the natural gas is transferred to shore through the mooring buoy.

16. The method of claim 1, wherein the natural gas is transferred from the second LNG Carrier through a subsea pipeline to an on-shore tie-in point via a beach crossing.

17. The method of claim 1, wherein the LNG is regasified using ambient air as a source of heat.

18. The method of claim 1, wherein the LNG is regasified through heat exchange with an intermediate fluid and the intermediate fluid is heated using ambient air as a source of heat.

19. The method of claim 18, wherein heat exchange between the ambient air and the LNG or intermediate fluid is encouraged through use of forced draft fans

20. The method of claim 1, further comprising flowing regasified natural gas into a second heat exchanger in which the regasified natural gas is heated and is transferred to shore as superheated vapor.

21. The method of claim 20, wherein the regasified natural gas is heated in the second heat exchanger using waste heat recovery from the second LNG Carrier.

22. The method of claim 1, wherein the LNG is regasified in a closed loop heat exchanger.

23. The method of claim 1, wherein the LNG is regasified in a finned tube heat exchanger.
